(19) United States
(12) Patent Application Publication
(10) Pub. No.: US 2014/0183216 A1
(43) Pub. Date: Jul. 3, 2014

(54) AUTOMATIC VENDING MACHINE

(71) Applicants: Hon Hai Precision Industry Co., Ltd., New Taipei (TW); Hong Fu Jin Precision Industry (WuHan) Co., Ltd., Wuhan (CN)

(72) Inventors: YUN-LUNG CHEN, New Taipei (TW); WEI-YONG MA, Wuhan (CN); REN-XI DOU, Wuhan (CN)

(73) Assignees: Hon hai Precision Industry Co., Ltd., New Taipei (TW); Hong Fu Jin Precision Industry (Wuhan) Co., Ltd., Wuhan (CN)

(21) Appl. No.: 13/974,041

(22) Filed: Aug. 22, 2013

(30) Foreign Application Priority Data
Dec. 29, 2012 (CN) 2012105890481

(51) Int. Cl. G07F 11/42

(52) U.S. Cl. CPC G07F 11/42
USPC 221/258

(57) ABSTRACT

A vending machine with reliable delivery of a bought item of goods includes a cabinet, a motor secured in the cabinet, a helical element, and a pressing member secured to the cabinet. The cabinet includes a bottom plate. A first end of the helical element is secured to the motor and is rotated by the motor. A gap is defined between the pressing member and the bottom plate to allow free rotation of the helical element thereunder. The pressing member is located within and above some coils of the helical element to carry items of goods being bought and ensures that no bought items of goods are snagged or caught by the second end of the helical element as it rotates helical element.

### BACKGROUND

1. Technical Field

The present disclosure relates to vending machines.

2. Description of Related Art

Vending machines allow customers to buy merchandise twenty four hours a day. When the customer retrieves the merchandise from the vending machine, a helical elementhelical element in a cabinet is rotated to push the merchandise out of the cabinet. However, a free end of the helical elementhelical element may catch or snag the merchandise, preventing the delivery to the customer. Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an automatic vending machine in accordance with an embodiment.

FIG. 2 is an isometric view of a securing member of the automatic vending machine of FIG. 1.

FIG. 3 is assembled view of the automatic vending machine of FIG. 1.

FIG. 4 is an enlarged view of a circled portion IV of FIG. 3.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

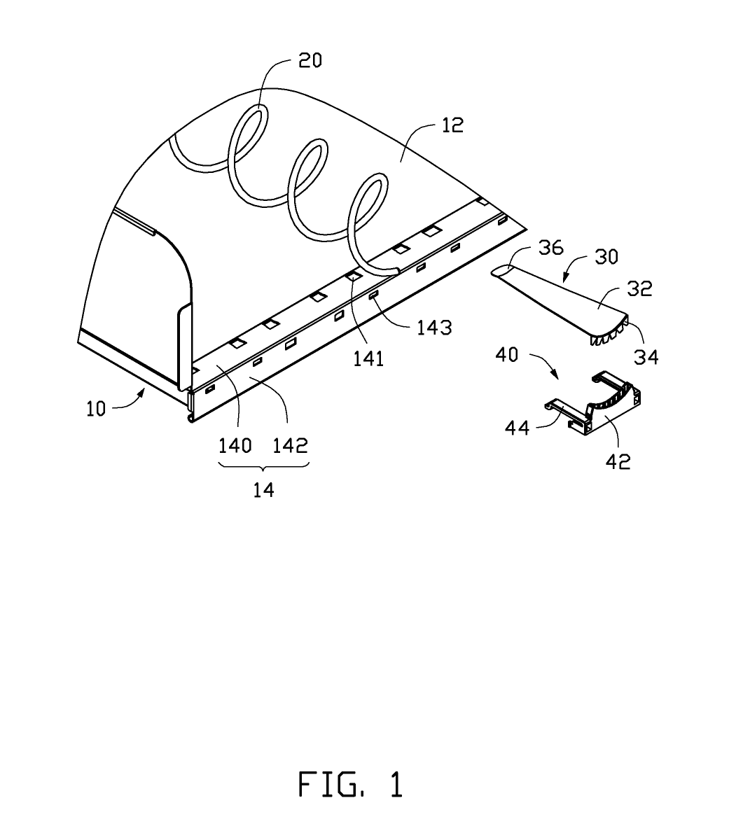

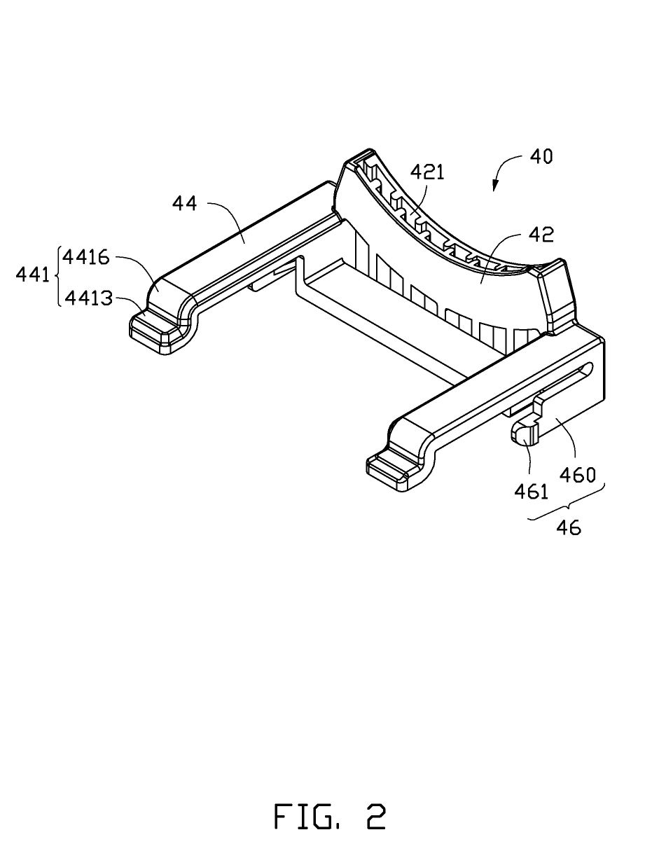

FIGS. 1 and 2 illustrate an automatic vending machine in accordance with an embodiment. The automatic vending machine comprises a cabinet 10, a helical element 20, a pressing member 30, and a securing member 40.

The cabinet 10 comprises a bottom plate 12, a mounting portion 14 extending from the bottom plate 12, and a rear plate 16 extending from the bottom plate 12. In one embodiment, the mounting portion 14 is substantially L-shaped, and the rear plate 16 is substantially perpendicular to the bottom plate 12. A motor 50 is secured to the rear plate 16, a first end of the helical element 20 is secured to the motor 50, so that the helical element 20 can be rotated by the motor 50. A second end of the helical element 20 is located above the mounting portion 14.

The mounting portion 14 comprises a first flange 140 and a second flange 142 substantially perpendicular to the first flange 140. The first flange 140 and the bottom plate 12 are located on a same plane. A plurality of securing holes 141 is defined in the first flange 140, and a plurality of mounting holes 143 is defined in the second flange 142.

The pressing member 30 comprises a main body 32, a fastening piece 34 extending from a first end of the pressing member 30, and a guiding piece 36 extending from a second end of the pressing member 30. In one embodiment, the fastening piece 34 is set with teeth at one end; the guiding piece 36 is slanted relative to the main body 32. A size of the first end of the main body 32 is greater than a size of the second end of the main body 32.

The securing member 40 comprises a securing plate 42, a pair of first securing arms 44 extending from the securing plate 42, and a pair of second securing arms 46 extending from the securing plate 42. In one embodiment, the pair of second securing arms 46 is substantially perpendicular to the securing plate 42 and the pair of first securing arms 44, and each second securing arm 46 is located below each first securing arm 44. A length of each first securing arm 44 is greater than a length of each second securing arm 46. A top portion of the securing plate 42 is substantially arc-shaped. A plurality of receiving slots 421 are defined in the top portion of the securing plate 42 and configured for receiving the teeth of the fastening piece 34.

A clipping portion 441 extends from each first securing arm 44 and comprises a connecting piece 4416 and a clipping piece 4413 extending from the connecting piece 4416. The clipping piece 4413 is substantially parallel to the first securing arm 44. In one embodiment, the clipping portion 441 further comprises an arc bottom edge 4411. Each second securing arm 46 comprises a second securing arm main body 460 and a hook 461 extending from the second securing arm main body 460.

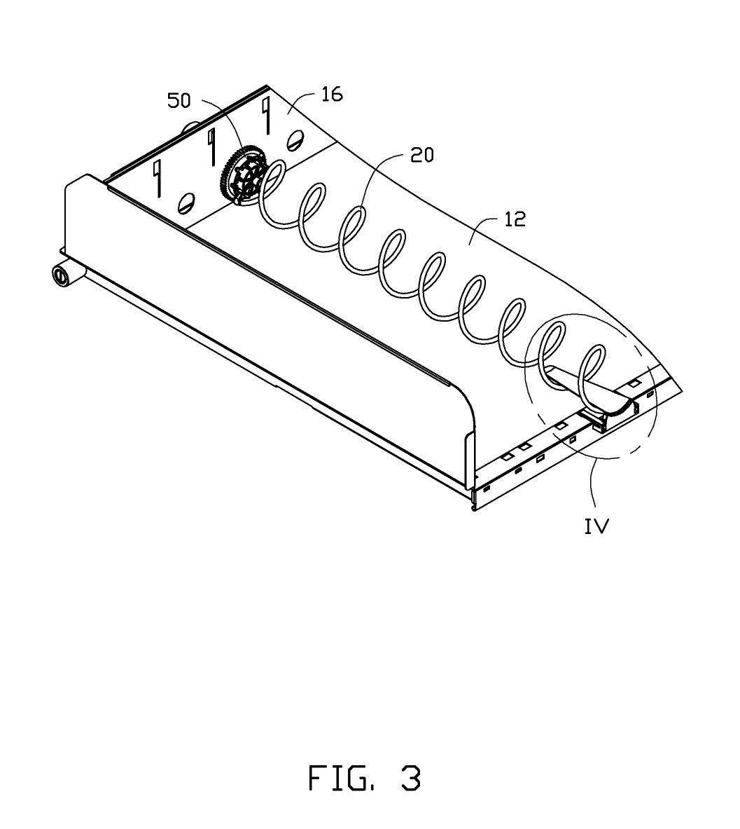

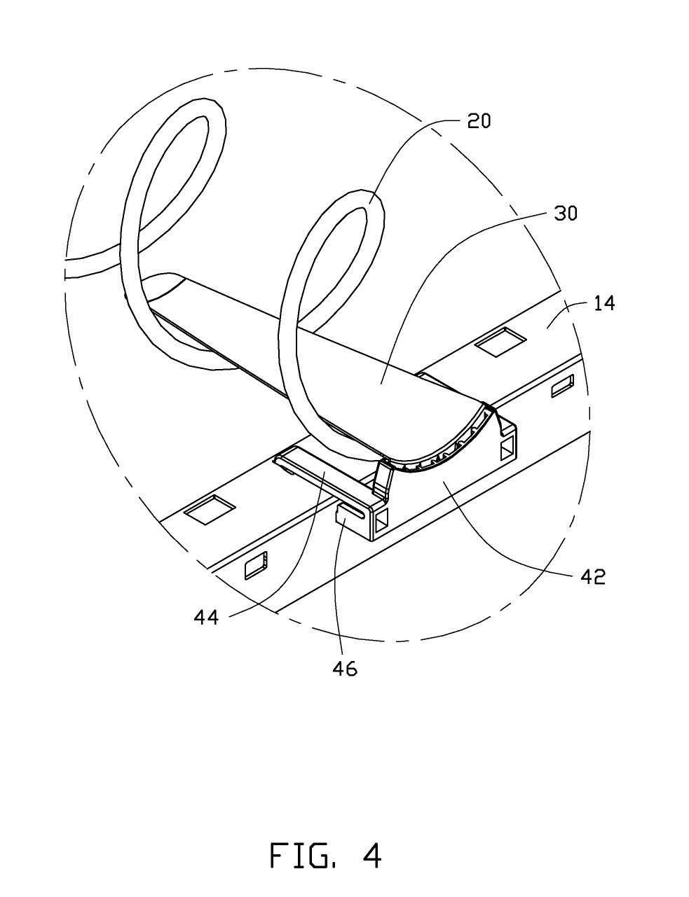

FIGS. 3-4 illustrate assembly of the automatic vending machine in accordance with an embodiment. In assembly, the two first securing arms 44 abut the first flange 140 and are located on opposite sides of the helical element 20. The two clipping portions 441 are inserted into two securing holes 141. The securing member 40 is moved away from the second flange 142, so that the arc bottom edge 4411 abuts an edge of the securing hole 141 that is adjacent to the second flange 142. The two clipping pieces 4413 are clipped to the bottom surface of the first flange 140, for preventing upward movement by the securing member 40. Simultaneously, the two hooks 461 are clipped into two mounting holes 143, to secure the securing member 40 to the mounting portion 14. The fastening piece 34 is engaged in the receiving slots 421, to secure the pressing member 30 to the securing member 40. The second end of the helical element 20 is pressed by the main body 32, so that the main body 32 prevents the second end of the helical element 20 from becoming warped. Simply by virtue of gravity, and the overall shape of the pressing member 30, the merchandise is guided to move along the helical element 20 by the guiding piece 36 and the pressing member 30.

In one embodiment, a gap is defined between the pressing member 30 and the bottom plate 12, so the pressing member 30 does not impede the free rotation of the helical element 20.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. An automatic vending machine comprising:
a cabinet comprising a bottom plate;
a motor secured in the cabinet;
a helical element; a first end of the helical element secured to the motor and being moveable by the motor; and
a pressing member secured to the cabinet; and a gap defined between the pressing member and the bottom plate;
wherein the pressing member is located on an interior of the helical element, to press a second end of the helical element.

2. The automatic vending machine of claim 1, wherein the pressing member comprises a main body, and the second end of the helical element is pressed by the main body.

3. The automatic vending machine of claim 2, wherein the pressing member further comprises a guiding piece connected to the main body, and an obtuse angle is defined between the guiding piece and the main body.

4. The automatic vending machine of claim 2, further comprising a securing member secured to the cabinet, wherein the pressing member is secured to the securing member.

5. The automatic vending machine of claim 4, wherein the pressing member further comprises a fastening piece substantially perpendicular to the main body, the securing member defines a plurality of receiving slots, and the fastening piece is received in the plurality of receiving slots.

6. The automatic vending machine of claim 5, wherein the fastening piece is teeth shaped, and the plurality of receiving slots is also teeth shaped.

7. The automatic vending machine of claim 4, wherein the securing member comprises a securing plate, a pair of first securing arms, and a pair of second securing arms; and each second securing arm is located below each first securing arm, and the pair of first securing arms and the pair of second securing arms are clipped to the cabinet.

8. The automatic vending machine of claim 7, wherein a length of each second securing arm is less than a length of each first securing arm.

9. The automatic vending machine of claim 7, wherein the cabinet comprises a mounting portion, the mounting portion comprises a first flange substantially parallel to the bottom plate; and the first flange defines two securing holes, and each first securing arm comprises a clipping portion engaged in each securing hole.

10. The automatic vending machine of claim 9, wherein the mounting portion further comprises a second flange substantially perpendicular to the first flange; the second flange defines two mounting holes, and each second securing arm comprises a hook clipped into each mounting hole.

11. An automatic vending machine comprising:
a cabinet comprising a bottom plate; a mounting portion located on a front end of the bottom plate;
a motor secured to a rear end of the bottom plate;
a helical element; a first end of the helical element secured to the motor and being moveable by the motor;
a securing member secured to the mounting portion; and
a pressing member secured to the mounting portion; and a gap defined between the pressing member and the bottom plate;
wherein the pressing member is located on an interior of the helical element, to press a second end of the helical element.

12. The automatic vending machine of claim 11, wherein the pressing member comprises a main body, and the second end of the helical element is pressed by the main body.

13. The automatic vending machine of claim 12, wherein the pressing member further comprises a guiding piece connected to the main body, and an obtuse angle is defined between the guiding piece and the main body.

14. The automatic vending machine of claim 12, wherein the pressing member further comprises a fastening piece substantially perpendicular to the main body, the securing member defines a plurality of receiving slots, and the fastening piece is received in the plurality of receiving slots.

15. The automatic vending machine of claim 14, wherein the fastening piece is teeth shaped, and the plurality of receiving slots is also teeth shaped.

16. The automatic vending machine of claim 11, wherein the securing member comprises a securing plate, a pair of first securing arms, and a pair of second securing arms;
and each second securing arm is located below each first securing arm, and the pair of first securing arms and the pair of second securing arms are clipped to the cabinet.

17. The automatic vending machine of claim 16, wherein each second securing arm is substantially perpendicular to the each first securing arm and the securing plate.

18. The automatic vending machine of claim 16, wherein a length of each second securing arm is less than a length of each first securing arm.

19. The automatic vending machine of claim 16, wherein the mounting portion comprises a first flange substantially parallel to the bottom plate; and the first flange defines two securing holes, and each first securing arm comprises a clipping portion engaged in each securing hole.

20. The automatic vending machine of claim 19, wherein the mounting portion further comprises a second flange substantially perpendicular to the first flange; the second flange defines two mounting holes, and each second securing arm comprises a hook clipped into each mounting hole.
